(19) United States
(12) Patent Application Publication
(10) Pub. No.: US 2022/0144975 A1
(43) Pub. Date: May 12, 2022

(54) CATALYST SYSTEM FOR PRODUCING OLEFIN POLYMERS WITH NO FINES

(71) Applicant: W. R. GRACE & CO.-CONN, Columbia, MD (US)

(72) Inventors: Jan VAN EGMOND, Columbia, MD (US); Stephen Lee VAN PELT, Columbia, MD (US)

(21) Appl. No.: 17/593,223

(22) PCT Filed: Mar. 13, 2020
(86) PCT No.: PCT/US2020/022556

§ 371 Date: Sep. 13, 2021

Related U.S. Application Data
(60) Provisional application No. 62/818,925, filed on Mar. 15, 2019.

(51) Int. Cl. C08F 4/646; C08F 2/01; C08F 10/06; C08F 2/34

(52) U.S. Cl. CPC C08F 4/6465; C08F 2/01; C08F 2410/04; C08F 2/34; C08F 10/06

(57) ABSTRACT

Olefin polymers are produced having a relatively high bulk density and a dramatically reduced amount of fines. The polymers are produced using a catalyst system containing a selectivity control agent. In one embodiment, the selectivity control agent is diisobutyldimethoxysilane.

### RELATED APPLICATIONS

The present application is based on and claims priority to U.S. Provisional Patent application Ser. No. 62/818,925, filed on Mar. 15, 2019, which is incorporated herein by reference.

### BACKGROUND

Polyolefin polymers are used in numerous and diverse applications and fields. Polyolefin polymers, for instance, are thermoplastic polymers that can be easily processed. The polyolefin polymers can also be recycled and reused. Polyolefin polymers are formed from hydrocarbons, such as ethylene and alpha-olefins, which are obtained from petrochemicals and are abundantly available.

Polypropylene polymers, which are one type of polyolefin polymers, generally have a linear structure based on a propylene monomer. Polypropylene polymers can have various different stereospecific configurations. Polypropylene polymers, for example, can be isotactic, syndiotactic, and atactic. Isotactic polypropylene is perhaps the most common form and can be highly crystalline. Polypropylene polymers that can be produced include homopolymers, modified polypropylene polymers, and polypropylene copolymers which include polypropylene terpolymers. By modifying the polypropylene or copolymerizing the propylene with other monomers, various different polymers can be produced having desired properties for a particular application. For example, polypropylene copolymers can be produced having elastomeric properties which greatly enhances the impact strength of the polymers.

Worldwide demand for olefin-based polymers continues to grow as applications for these polymers become more diverse and more sophisticated. Known are Ziegler-Natta catalyst compositions for the production of olefin-based polymers. Ziegler-Natta catalyst compositions typically include a catalyst containing a transition metal halide (i.e., titanium, chromium, vanadium), a cocatalyst such as an organoaluminum compound, and optionally an external electron donor. Ziegler-Natta catalyzed olefin-based polymers typically exhibit a narrow range of molecular weight distribution.

Given the perennial emergence of new applications for olefin-based polymers and the increasing demand for olefin polymers, improvements are needed not only in the production of olefin polymers, but also in the resulting properties of the polymers. For example, one problem faced during the production of olefin polymers is the ability to efficiently handle and transfer the polymer resins once produced. The different polymerization processes, for instance, can produce polymer resins that do not have optimal flow properties and/or can contain relatively high levels of fines. Consequently, the polymers are not only difficult to remove from reactors or transfer from one reactor to the next, but also can foul the equipment used during production of the polymers.

### SUMMARY

The present disclosure is generally directed to an improved polymer catalyst system and to a process for using the catalyst system to produce olefin polymers, such as polypropylene polymers, polyethylene polymers, copolymers thereof, and terpolymers thereof. The catalyst system of the present disclosure has been found to unexpectedly produce polymers having higher bulk densities with dramatically reduced fines. Consequently, olefin polymers can be produced at higher rates, that are easier to handle, and that have less potential for fouling the equipment.

In one embodiment, for instance, the present disclosure is directed to a process for producing olefin polymers. The process includes polymerizing one or more olefin monomers in the presence of a Ziegler-Natta catalyst system in a gas phase polymerization reactor. The catalyst system can be a non-prepolymerized catalyst system and can include a solid catalyst component, at least one selectivity control agent, and optionally an activity limiting agent. The solid catalyst component can comprise a magnesium moiety, such as a magnesium halide, a titanium moiety, and an internal electron donor. In one embodiment, the internal electron donor may comprise an aryl diester.

In accordance with the present disclosure, the selectivity control agent comprises a silane having the following chemical structure:

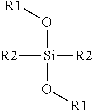

wherein R₁ is a C1 to C6 alkyl group, such as a methyl group. R₂, on the other hand is a C3 to C8 branched alkyl group. In one embodiment, for instance, the selectivity control agent is diisobutyldimethoxysilane. Although, in the past, selectivity control agents have only had moderate affects on polymerization processes, it was discovered that the selectivity control agent described above can dramatically influence polymer morphology and production when used in the process of the present disclosure.

In one embodiment, the selectivity control agent is used in conjunction with an activity limiting agent. The activity limiting agent may comprise a carboxylic acid ester. For instance, the activity limiting agent may comprise isopropyl myristate, pentyl valerate, or mixtures thereof.

The catalyst system can also include a cocatalyst. The cocatalyst may comprise a hydrocarbon aluminum compound, such as triethylaluminum.

In still another embodiment, the catalyst system may include a second selectivity control agent in addition to the selectivity control agent described above. The second selectivity control agent may comprise an alkoxy silane. For example, the second selectivity control agent may comprise dicyclopentyldimethoxysilane, di-tert-butyldimethoxysilane, methylcyclohexyldimethoxysilane, methylcyclohexyldiethoxysilane, ethylcyclohexyldimethoxysilane, diphenyldimethoxysilane, diisopropyldimethoxysilane, di-n-propyldimethoxysilane, isobutylisopropyldimethoxysilane, di-n-butyldimethoxysilane, cyclopentyltrimethoxysilane, isopropyltrimethoxysilane, n-propyltrimethoxysilane, n-propyltriethoxysilane, ethyltriethoxysilane, tetramethoxysilane, tetraethoxysilane, diethylaminotriethoxysilane, cyclopentylpyrrolidinodimethoxysilane, bis(pyrrolidino)dimethoxysilane, bis(perhydroisoquinolino)dimethoxysilane, dimethyldimethoxysilane or mixtures thereof.

In one embodiment, the catalyst component can further include an epoxy compound, an organic phosphorus compound, and an organosilicon compound.

In one embodiment, the process of the present disclosure can be used to produce a polypropylene homopolymer. The polypropylene homopolymer, for instance, can have a bulk density of greater than about 0.38 g/cc. The polypropylene homopolymer can also contain fines in an amount less than 1% by weight. As used herein, “fines” refer to particles having a particle size of less than 120 mesh using, for instance, GRADE X2000 particle-size analyzer, which is commercially available from Rotex, which operates as part of the Process Equipment Group, owned by Hillenbrand, Inc.

In addition to homopolymers, the process of the present disclosure can also be used to produce copolymers, such as propylene and ethylene copolymers. In one embodiment, for instance, the catalyst system can be used to produce a heterophasic polymer. The heterophasic polymer may include a first polymer phase comprising a polypropylene homopolymer or a polypropylene random copolymer. The polymer may further include a second polymer phase combined with a first polymer phase. The second polymer phase may include an elastomeric propylene ethylene copolymer. In one embodiment, the first polymer phase may be formed in a first reactor and the second polymer phase may be formed in a second reactor. The catalyst system of the present disclosure can remain active in both the first reactor and the second reactor.

In still another embodiment, the catalyst system of the present disclosure can be used to produce a terpolymer from three or more olefin monomers.

Copolymers and terpolymers made according to the present disclosure can have a bulk density of generally greater than about 0.38 g/cc and can contain less than 1% fines by weight.

The present disclosure is also directed to a non-prepolymerized Ziegler-Natta catalyst system. The catalyst system includes a solid catalyst component as described above including a magnesium moiety, a titanium moiety, and an internal electron donor. The catalyst system further includes a cocatalyst that comprises an alkly aluminum compound, such as triethylaluminum. In accordance with the present disclosure, the catalyst system includes a selectivity control agent comprising diisobutyldimethoxysilane. The selectivity control agent can be present in conjunction with an activity limiting agent, which may comprise a carboxylic acid ester. The activity limiting agent can be present in conjunction with one or more selectivity control agents at a mole ratio of from about 90:10 to about 50:50, such as from about 85:15 to about 55:45.

Other features and aspects of the present disclosure are discussed in greater detail below.

### BRIEF DESCRIPTION OF THE DRAWINGS

FIG. 1 is a graphical representation of some of the results shown in the example below; and

FIG. 2 is a graphical representation of some of the results shown in the example below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to catalyst systems for producing polyolefin polymers, particularly polypropylene polymers. The present disclosure is also directed to methods of polymerizing and copolymerizing olefins using the catalyst system. In general, the catalyst system of the present disclosure includes a solid catalyst component combined with a particular selectivity control agent. The selectivity control agent generally has the following chemical structure:

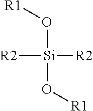

wherein R₁ is a C1 to C6 alkyl group, and R₂ is a C3 to C8 branched alkyl group. For example, in one embodiment, the selectivity control agent is diisobutyldimethoxysilane. It was discovered that the above selectivity control agent, when used in a non-prepolymerized Ziegler-Natta catalyst system, produces polymers having a high bulk density and a dramatically reduced amount of fines. Thus, the polymers can be produced more efficiently and can be easily handled. The catalyst system of the present disclosure is particularly well suited for use in gas phase reactors, such as reactors that include a fluidized bed.

The catalyst system of the present disclosure offers many benefits and advantages. In particular, polymers, such as olefin homopolymers, copolymers and terpolymers, can be produced at higher rates and can be produced more efficiently. The polymer resin or powder that is produced has much less potential for fouling of the reactor or the equipment due to the reduction of fines and a higher bulk density value.

Of particular advantage, it was discovered that the above advantages also translate into polymer processes for producing olefin copolymers, such as polypropylene random copolymers, including polymers with elastomeric properties. For example, when producing copolymer powders, the catalyst system of the present disclosure can produce polymers with higher bulk density and/or with higher partial pressures for allowing higher rates of production. The catalyst system can produce the copolymers with higher catalyst productivity in comparison to many conventional catalyst systems. In addition, the catalyst system of the present disclosure can produce polypropylene random copolymers having higher ethylene content while maintaining good morphology. When producing impact polymers made in multiple reactors, the polymer resin can be passed from a first reactor to a second reactor with less fines which can dramatically improve handling of the polymer, prevent stickiness, and reduce fouling.

Ultimately, the selectivity control agent used in the catalyst system of the present disclosure produces polymer resins having excellent flow properties. The selectivity control agent, for instance, has been found to increase bulk density while decreasing fines over a wide range of polymer products including homopolymers, copolymers, terpolymers, and the like. In addition, it was discovered that different polymers can be produced with a wide variety of melt flow rates without increasing fine levels. For instance, high melt flow rate polymers can be produced while having an unexpectedly low amount of fines. As shown above, the selectivity control agent of the present disclosure is a silane having balanced alkyl groups extending from a silicon nucleus. Although unknown, it is believed that the selectivity control agent of the present disclosure moderates or regulates the kinetics of the catalyst system in order to produce polymers having improved morphology. This effect is surprising in that selectivity control agents used in the past have not shown a similar effect.

The selectivity control agent of the present disclosure is part of a catalyst system that includes a solid catalyst component. The solid catalyst component can include (i) magnesium, (ii) a transition metal compound of an element from Periodic Table groups IV to VIII, (iii) a halide, an oxyhalide, and/or an alkoxide of (i) and/or (ii), and (iv) combinations of (i), (ii), and (iii). Nonlimiting examples of suitable catalyst components include halides, oxyhalides, and alkoxides of magnesium, manganese, titanium, vanadium, chromium, molybdenum, zirconium, hafnium, and combinations thereof.

In one embodiment, the preparation of the catalyst component involves halogenation of mixed magnesium and titanium alkoxides.

In various embodiments, the catalyst component is a magnesium moiety compound (MagMo), a mixed magnesium titanium compound (MagTi), or a benzoate-containing magnesium chloride compound (BenMag). In one embodiment, the catalyst precursor is a magnesium moiety (“MagMo”) precursor. The MagMo precursor includes a magnesium moiety. Nonlimiting examples of suitable magnesium moieties include anhydrous magnesium chloride and/or its alcohol adduct, magnesium alkoxide or aryloxide, mixed magnesium alkoxy halide, and/or carboxylated magnesium dialkoxide or aryloxide. In one embodiment, the MagMo precursor is a magnesium di(C₁₋₄)alkoxide. In a further embodiment, the MagMo precursor is diethoxymagnesium.

In another embodiment, the catalyst component is a mixed magnesium/titanium compound (“MagTi”). The “MagTi precursor” has the formula Mg_{d}Ti(OR^{e})fX_{g} wherein R^{e} is an aliphatic or aromatic hydrocarbon radical having 1 to 14 carbon atoms or COR′ wherein R′ is an aliphatic or aromatic hydrocarbon radical having 1 to 14 carbon atoms; each OR^{e} group is the same or different; X is independently chlorine, bromine or iodine, preferably chlorine; d is 0.5 to 56, or 2 to 4; f is 2 to 116 or 5 to 15; and g is 0.5 to 116, or 1 to 3. The precursors are prepared by controlled precipitation through removal of an alcohol from the reaction mixture used in their preparation. In an embodiment, a reaction medium comprises a mixture of an aromatic liquid, especially a chlorinated aromatic compound, most especially chlorobenzene, with an alkanol, especially ethanol. Suitable halogenating agents include titanium tetrabromide, titanium tetrachloride or titanium trichloride, especially titanium tetrachloride. Removal of the alkanol from the solution used in the halogenation, results in precipitation of the solid precursor, having especially desirable morphology and surface area. Moreover, the resulting precursors are particularly uniform in particle size.

In another embodiment, the catalyst precursor is a benzoate-containing magnesium chloride material (“BenMag”). As used herein, a “benzoate-containing magnesium chloride” (“BenMag”) can be a catalyst (i.e., a halogenated catalyst component) containing a benzoate internal electron donor. The BenMag material may also include a titanium moiety, such as a titanium halide. The benzoate internal donor is labile and can be replaced by other electron donors during catalyst and/or catalyst synthesis. Nonlimiting examples of suitable benzoate groups include ethyl benzoate, methyl benzoate, ethyl p-methoxybenzoate, methyl p-ethoxybenzoate, ethyl p-ethoxybenzoate, ethyl p-chlorobenzoate. In one embodiment, the benzoate group is ethyl benzoate. In an embodiment, the BenMag catalyst component may be a product of halogenation of any catalyst component (i.e., a MagMo precursor or a MagTi precursor) in the presence of a benzoate compound.

In another embodiment, the solid catalyst component can be formed from a magnesium moiety, a titanium moiety, an epoxy compound, an organic phosphorus compound, an organosilicon compound, and an internal electron donor. For example, in one embodiment, a halide-containing magnesium compound can be dissolved in a mixture that includes an epoxy compound, an organic phosphorus compound, and a hydrocarbon solvent. The resulting solution can be treated with a titanium compound in the presence of an organosilicon compound and optionally with an internal electron donor to form a solid precipitate. The solid precipitate can then be treated with further amounts of a titanium compound. The titanium compound used to form the catalyst can have the following chemical formula:

Ti(OR)_{g}X_{4-g}

where each R is independently a C₁-C₄ alkyl; X is Br, Cl, or I; and g is 0, 1, 2, 3, or 4.

In some embodiments, the organosilicon is a monomeric or polymeric compound. The organosilicon compound may contain —Si—O—Si— groups inside of one molecule or between others. Other illustrative examples of an organosilicon compound include polydialkylsiloxane and/or tetraalkoxysilane. Such compounds may be used individually or as a combination thereof. The organosilicon compound may be used in combination with aluminum alkoxides and an internal electron donor.

The aluminum alkoxide referred to above may be of formula Al(OR′)₃ where each R′ is individually a hydrocarbon with up to 20 carbon atoms. This may include where each R′ is individually methyl, ethyl, n-propyl, iso-propyl, n-butyl, sec-butyl, tert-butyl, n-pentyl, iso-pentyl, neo-pentyl, etc.

Examples of the halide-containing magnesium compounds include magnesium chloride, magnesium bromide, magnesium iodide, and magnesium fluoride. In one embodiment, the halide-containing magnesium compound is magnesium chloride.

Illustrative of the epoxy compounds include, but are not limited to, glycidyl-containing compounds of the Formula:

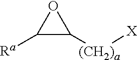

wherein “a” is from 1, 2, 3, 4, or 5, X is F, Cl, Br, I, or methyl, and R^{a} is H, alkyl, aryl, or cyclyl. In one embodiment, the alkylepoxide is epichlorohydrin. In some embodiments, the epoxy compound is a haloalkylepoxide or a nonhaloalkylepoxide.

According to some embodiments, the epoxy compound is selected from the group consisting of ethylene oxide; propylene oxide; 1,2-epoxybutane; 2,3-epoxybutane; 1,2-epoxyhexane; 1,2-epoxyoctane; 1,2-epoxydecane; 1,2-epoxydodecane; 1,2-epoxytetradecane; 1,2-epoxyhexadecane; 1,2-epoxyoctadecane; 7,8-epoxy-2-methyloctadecane; 2-vinyl oxirane; 2-methyl-2-vinyl oxirane; 1,2-epoxy-5-hexene; 1,2-epoxy-7-octene; 1-phenyl-2,3-epoxypropane; 1-(1-naphthyl)-2,3-epoxypropane; 1-cyclohexyl-3,4-epoxybutane; 1,3-butadiene dioxide; 1,2,7,8-diepoxyoctane; cyclopentene oxide; cyclooctene oxide; α-pinene oxide; 2,3-epoxynorbornane; limonene oxide; cyclodecane epoxide; 2,3,5,6-diepoxynorbornane; styrene oxide; 3-methylstyrene oxide; 1,2-epoxybutylbenzene; 1,2-epoxyoctylbenzene; stilbene oxide; 3-vinylstyrene oxide; 1-(1-methyl-1,2-epoxyethyl)-3-(1-methylvinyl benzene); 1,4-bis(1,2-epoxypropyl)benzene; 1,3-bis(1,2-epoxy-1-methylethyl)benzene; 1,4-bis(1,2-epoxy-1-methylethyl)benzene; epifluorohydrin; epichlorohydrin; epibromohydrin; hexafluoropropylene oxide; 1,2-epoxy-4-fluorobutane; 1-(2,3-epoxypropyl)-4-fluorobenzene; 1-(3,4-epoxybutyl)-2-fluorobenzene; 1-(2,3-epoxypropyl)-4-chlorobenzene; 1-(3,4-epoxybutyl)-3-chlorobenzene; 4-fluoro-1,2-cyclohexene oxide; 6-chloro-2,3-epoxybicyclo[2.2.1]heptane; 4-fluorostyrene oxide; 1-(1,2-epoxypropyl)-3-trifluorobenzene; 3-acetyl-1,2-epoxypropane; 4-benzoyl-1,2-epoxybutane; 4-(4-benzoyl)phenyl-1,2-epoxybutane; 4,4′-bis(3,4-epoxybutyl)benzophenone; 3,4-epoxy-1-cyclohexanone; 2,3-epoxy-5-oxobicyclo[2.2.1]heptane; 3-acetylstyrene oxide; 4-(1,2-epoxypropyl)benzophenone; glycidyl methyl ether; butyl glycidyl ether; 2-ethylhexyl glycidyl ether; allyl glycidyl ether; ethyl 3,4-epoxybutyl ether; glycidyl phenyl ether; glycidyl 4-tert-butylphenyl ether; glycidyl 4-chlorophenyl ether; glycidyl 4-methoxyphenyl ether; glycidyl 2-phenylphenyl ether; glycidyl 1-naphthyl ether; glycidyl 2-phenylphenyl ether; glycidyl 1-naphthyl ether; glycidyl 4-indolyl ether; glycidyl N-methyl-α-quinolon-4-yl ether; ethyleneglycol diglycidyl ether; 1,4-butanediol diglycidyl ether; 1,2-diglycidyloxybenzene; 2,2-bis(4-glycidyloxyphenyl)propane; tris(4-glycidyloxyphenyl)methane; poly(oxypropylene)triol triglycidyl ether; a glycidic ether of phenol novolac; 1,2-epoxy-4-methoxycyclohexane; 2,3-epoxy-5,6-dimethoxybicyclo[2.2.1]heptane; 4-methoxystyrene oxide; 1-(1,2-epoxybutyl)-2-phenoxybenzene; glycidyl formate; glycidyl acetate; 2,3-epoxybutyl acetate; glycidyl butyrate; glycidyl benzoate; diglycidyl terephthalate; poly(glycidyl acrylate); poly(glycidyl methacrylate); a copolymer of glycidyl acrylate with another monomer; a copolymer of glycidyl methacrylate with another monomer; 1,2-epoxy-4-methoxycarbonylcyclohexane; 2,3-epoxy-5-butoxycarbonylbicyclo[2.2.1]heptane; ethyl 4-(1,2-epoxyethyl)benzoate; methyl 3-(1,2-epoxybutyl)benzoate; methyl 3-(1,2-epoxybutyl)-5-pheylbenzoate; N,N-glycidyl-methylacetamide; N,N-ethylglycidylpropionamide; N,N-glycidylmethylbenzamide; N-(4,5-epoxypentyl)-N-methyl-benzamide; N,N-diglycylaniline; bis(4-diglycidylaminophenyl)methane; poly(N,N-glycidylmethylacrylamide); 1,2-epoxy-3-(diphenylcarbamoyl)cyclohexane; 2,3-epoxy-6-(dimethylcarbamoyl)bicycle[2.2.1]heptane; 2-(dimethylcarbamoyl)styrene oxide; 4-(1,2-epoxybutyl)-4′-(dimethylcarbamoyl)biphenyl; 4-cyano-1,2-epoxybutane; 1-(3-cyanophenyl)-2,3-epoxybutane; 2-cyanostyrene oxide; and 6-cyano-1-(1,2-epoxy-2-phenylethyl)naphthalene.

As an example of the organic phosphorus compound, phosphate acid esters such as trialkyl phosphate acid ester may be used. Such compounds may be represented by the formula:

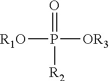

wherein R₁, R₂, and R₃ are each independently selected from the group consisting of methyl, ethyl, and linear or branched (C₃-C₁₀) alkyl groups. In one embodiment, the trialkyl phosphate acid ester is tributyl phosphate acid ester.

In still another embodiment, a substantially spherical MgCl₂-nEtOH adduct may be formed by a spray crystallization process. In the process, a MgCl₂-nROH melt, where n is 1-6, is sprayed inside a vessel while conducting inert gas at a temperature of 20-80° C. into the upper part of the vessel. The melt droplets are transferred to a crystallization area into which inert gas is introduced at a temperature of −50 to 20° C. crystallizing the melt droplets into nonagglomerated, solid particles of spherical shape. The spherical MgCl₂ particles are then classified into the desired size. Particles of undesired size can be recycled. In preferred embodiments for catalyst synthesis the spherical MgCl₂ precursor has an average particle size (Malvern d₅₀) of between about 15-150 microns, preferably between 20-100 microns, and most preferably between 35-85 microns.

The catalyst component may be converted to a solid catalyst by way of halogenation. Halogenation includes contacting the catalyst component with a halogenating agent in the presence of the internal electron donor. Halogenation converts the magnesium moiety present in the catalyst component into a magnesium halide support upon which the titanium moiety (such as a titanium halide) is deposited. Not wishing to be bound by any particular theory, it is believed that during halogenation the internal electron donor (1) regulates the position of titanium on the magnesium-based support, (2) facilitates conversion of the magnesium and titanium moieties into respective halides and (3) regulates the crystallite size of the magnesium halide support during conversion. Thus, provision of the internal electron donor yields a catalyst composition with enhanced stereoselectivity.

In an embodiment, the halogenating agent is a titanium halide having the formula Ti(OR^{e})_{f}Xₕ wherein R^{e} and X are defined as above, f is an integer from 0 to 3; h is an integer from 1 to 4; and f+h is 4. In an embodiment, the halogenating agent is TiCl₄. In a further embodiment, the halogenation is conducted in the presence of a chlorinated or a non-chlorinated aromatic liquid, such as dichlorobenzene, o-chlorotoluene, chlorobenzene, benzene, toluene, or xylene. In yet another embodiment, the halogenation is conducted by use of a mixture of halogenating agent and chlorinated aromatic liquid comprising from 40 to 60 volume percent halogenating agent, such as TiCl₄.

The reaction mixture can be heated during halogenation. The catalyst component and halogenating agent are contacted initially at a temperature of less than about 10° C., such as less than about 0° C., such as less than about −10° C., such as less than about −20° C., such as less than about −30° C. The initial temperature is generally greater than about −50° C., such as greater than about −40° C. The mixture is then heated at a rate of 0.1 to 10.0° C./minute, or at a rate of 1.0 to 5.0° C./minute. The internal electron donor may be added later, after an initial contact period between the halogenating agent and catalyst component. Temperatures for the halogenation are from 20° C. to 150° C. (or any value or subrange therebetween), or from 0° C. to 120° C. Halogenation may be continued in the substantial absence of the internal electron donor for a period from 5 to 60 minutes, or from 10 to 50 minutes.

The manner in which the catalyst component, the halogenating agent and the internal electron donor are contacted may be varied. In an embodiment, the catalyst component is first contacted with a mixture containing the halogenating agent and a chlorinated aromatic compound. The resulting mixture is stirred and may be heated if desired. Next, the internal electron donor is added to the same reaction mixture without isolating or recovering of the precursor. The foregoing process may be conducted in a single reactor with addition of the various ingredients controlled by automated process controls.

In one embodiment, the catalyst component is contacted with the internal electron donor before reacting with the halogenating agent.

Contact times of the catalyst component with the internal electron donor are at least 10 minutes, or at least 15 minutes, or at least 20 minutes, or at least 1 hour at a temperature from at least −30° C., or at least −20° C., or at least 10° C. up to a temperature of 150° C., or up to 120° C., or up to 115° C., or up to 110° C.

In one embodiment, the catalyst component, the internal electron donor, and the halogenating agent are added simultaneously or substantially simultaneously.

The halogenation procedure may be repeated one, two, three, or more times as desired. In an embodiment, the resulting solid material is recovered from the reaction mixture and contacted one or more times in the absence (or in the presence) of the same (or different) internal electron donor components with a mixture of the halogenating agent in the chlorinated aromatic compound for at least about 10 minutes, or at least about 15 minutes, or at least about 20 minutes, and up to about 10 hours, or up to about 45 minutes, or up to about 30 minutes, at a temperature from at least about −20° C., or at least about 0° C., or at least about 10° C., to a temperature up to about 150° C., or up to about 120° C., or up to about 115° C.

After the foregoing halogenation procedure, the resulting solid catalyst composition is separated from the reaction medium employed in the final process, by filtering for example, to produce a moist filter cake. The moist filter cake may then be rinsed or washed with a liquid diluent to remove unreacted TiCl₄ and may be dried to remove residual liquid, if desired. Typically the resultant solid catalyst composition is washed one or more times with a “wash liquid,” which is a liquid hydrocarbon such as an aliphatic hydrocarbon such as isopentane, isooctane, isohexane, hexane, pentane, or octane. The solid catalyst composition then can be separated and dried or slurried in a hydrocarbon, especially a relatively heavy hydrocarbon such as mineral oil for further storage or use.

In one embodiment, the resulting solid catalyst composition has a titanium content of from about 1.0 percent by weight to about 6.0 percent by weight, based on the total solids weight, or from about 1.5 percent by weight to about 4.5 percent by weight, or from about 2.0 percent by weight to about 3.5 percent by weight. The weight ratio of titanium to magnesium in the solid catalyst composition is suitably between about 1:3 and about 1:160, or between about 1:4 and about 1:50, or between about 1:6 and 1:30. In an embodiment, the internal electron donor may be present in the catalyst composition in a molar ratio of internal electron donor to magnesium of from about 0.005:1 to about 1:1, or from about 0.01:1 to about 0.4:1. Weight percent is based on the total weight of the catalyst composition.

The catalyst composition may be further treated by one or more of the following procedures prior to or after isolation of the solid catalyst composition. The solid catalyst composition may be contacted (halogenated) with a further quantity of titanium halide compound, if desired; it may be exchanged under metathesis conditions with an acid chloride, such as phthaloyl dichloride or benzoyl chloride; and it may be rinsed or washed, heat treated; or aged. The foregoing additional procedures may be combined in any order or employed separately, or not at all.

As described above, the catalyst composition can include a combination of a magnesium moiety, a titanium moiety and the internal electron donor. The catalyst composition is produced by way of the foregoing halogenation procedure which converts the catalyst component and the internal electron donor into the combination of the magnesium and titanium moieties, into which the internal electron donor is incorporated. The catalyst component from which the catalyst composition is formed can be any of the above described catalyst precursors, including the magnesium moiety precursor, the mixed magnesium/titanium precursor, the benzoate-containing magnesium chloride precursor, the magnesium, titanium, epoxy, and phosphorus precursor, or the spherical precursor.

Various different types of internal electron donors may be incorporated into the solid catalyst component. In one embodiment, the internal electron donor is an aryl diester, such as a phenylene-substituted diester. In one embodiment, the internal electron donor may have the following chemical structure:

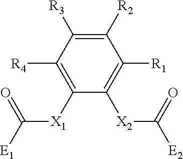

wherein R₁ R₂, R₃ and R₄ are each a hydrocarbyl group having from 1 to 20 carbon atoms, the hydrocarbyl group having a branched or linear structure or comprising a cycloalkyl group having from 7 to 15 carbon atoms, and where E₁ and E₂ are the same or different and selected from the group consisting of an alkyl having 1 to 20 carbon atoms, a substituted alkyl having 1 to 20 carbon atoms, an aryl having 1 to 20 carbon atoms, a substituted aryl having 1 to 20 carbon atoms, or an inert functional group having 1 to 20 carbon atoms and optionally containing heteroatoms, and wherein X₁ and X₂ are each O, S, an alkyl group, or NR₅ and wherein R₅ is a hydrocarbyl group having 1 to 20 carbon atoms or is hydrogen.

As used herein, the term “hydrocarbyl” and “hydrocarbon” refer to substituents containing only hydrogen and carbon atoms, including branched or unbranched, saturated or unsaturated, cyclic, polycyclic, fused, or acyclic species, and combinations thereof. Nonlimiting examples of hydrocarbyl groups include alkyl-, cycloalkyl-, alkenyl-, alkadienyl-, cycloalkenyl-, cycloalkadienyl-, aryl-, aralkyl, alkylaryl, and alkynyl-groups.

As used herein, the terms “substituted hydrocarbyl” and “substituted hydrocarbon” refer to a hydrocarbyl group that is substituted with one or more nonhydrocarbyl substituent groups. A nonlimiting example of a nonhydrocarbyl substituent group is a heteroatom. As used herein, a “heteroatom” refers to an atom other than carbon or hydrogen. The heteroatom can be a non-carbon atom from Groups IV, V, VI, and VII of the Periodic Table. Nonlimiting examples of heteroatoms include: halogens (F, Cl, Br, I), N, O, P, B, S, and Si. A substituted hydrocarbyl group also includes a halohydrocarbyl group and a silicon-containing hydrocarbyl group. As used herein, the term “halohydrocarbyl” group refers to a hydrocarbyl group that is substituted with one or more halogen atoms. As used herein, the term “silicon-containing hydrocarbyl group” is a hydrocarbyl group that is substituted with one or more silicon atoms. The silicon atom(s) may or may not be in the carbon chain.

In addition to the solid catalyst component as described above, the catalyst system of the present disclosure can also include a cocatalyst.

The cocatalyst may include hydrides, alkyls, or aryls of aluminum, lithium, zinc, tin, cadmium, beryllium, magnesium, and combinations thereof. In an embodiment, the cocatalyst is a hydrocarbyl aluminum cocatalyst represented by the formula R₃Al wherein each R is an alkyl, cycloalkyl, aryl, or hydride radical; at least one R is a hydrocarbyl radical; two or three R radicals can be joined in a cyclic radical forming a heterocyclic structure; each R can be the same or different; and each R, which is a hydrocarbyl radical, has 1 to 20 carbon atoms, and preferably 1 to 10 carbon atoms. In a further embodiment, each alkyl radical can be straight or branched chain and such hydrocarbyl radical can be a mixed radical, i.e., the radical can contain alkyl, aryl, and/or cycloalkyl groups. Nonlimiting examples of suitable radicals are: methyl, ethyl, n-propyl, isopropyl, n-butyl, isobutyl, tert-butyl, n-pentyl, neopentyl, n-hexyl, 2-methylpentyl, n-heptyl, n-octyl, isooctyl, 2-ethylhexyl, 5,5-dimethylhexyl, n-nonyl, n-decyl, isodecyl, n-undecyl, n-dodecyl.

Nonlimiting examples of suitable hydrocarbyl aluminum compounds are as follows: triisobutylaluminum, tri-n-hexylaluminum, diisobutylaluminum hydride, di-n-hexylaluminum hydride, isobutylaluminum dihydride, n-hexylaluminum dihydride, diisobutylhexylaluminum, isobutyldihexylaluminum, trimethylaluminum, triethylaluminum, tri-n-propylaluminum, triisopropylaluminum, tri-n-butylaluminum, tri-n-octylaluminum, tri-n-decylaluminum, tri-n-dodecylaluminum. In an embodiment, the cocatalyst is selected from triethylaluminum, triisobutylaluminum, tri-n-hexylaluminum, diisobutylaluminum hydride, and di-n-hexylaluminum hydride.

In an embodiment, the cocatalyst is triethylaluminum. The molar ratio of aluminum to titanium is from about 5:1 to about 500:1, or from about 10:1 to about 200:1, or from about 15:1 to about 150:1, or from about 20:1 to about 100:1. In another embodiment, the molar ratio of aluminum to titanium is about 45:1.

The solid catalyst component and the cocatalyst are combined with a selectivity control agent in accordance with the present disclosure. In the past, selectivity control agents were typically used to enhance catalyst stereoselectivity and reduce xylene soluble material. The selectivity control agent of the present disclosure, on the other hand, has been found to dramatically influence polymer morphology and produce polymers having a high bulk density with low fines.

In one embodiment, the catalyst system may include an activity limiting agent (ALA). As used herein, an “activity limiting agent” (“ALA”) is a material that reduces catalyst activity at elevated temperature (i.e., temperature greater than about 85° C.). An ALA inhibits or otherwise prevents polymerization reactor upset and ensures continuity of the polymerization process. Typically, the activity of Ziegler-Natta catalysts increases as the reactor temperature rises. Ziegler-Natta catalysts also typically maintain high activity near the melting point temperature of the polymer produced. The heat generated by the exothermic polymerization reaction may cause polymer particles to form agglomerates and may ultimately lead to disruption of continuity for the polymer production process. The ALA reduces catalyst activity at elevated temperature, thereby preventing reactor upset, reducing (or preventing) particle agglomeration, and ensuring continuity of the polymerization process.

The activity limiting agent may be a carboxylic acid ester. The aliphatic carboxylic acid ester may be a C₄-C₃₀ aliphatic acid ester, may be a mono- or a poly- (two or more) ester, may be straight chain or branched, may be saturated or unsaturated, and any combination thereof. The C₄-C₃₀ aliphatic acid ester may also be substituted with one or more Group 14, 15 or 16 heteroatom containing substituents. Nonlimiting examples of suitable C₄-C₃₀ aliphatic acid esters include C₁₋₂₀ alkyl esters of aliphatic C₄₋₃₀ monocarboxylic acids, C₁₋₂₀ alkyl esters of aliphatic C₈₋₂₀ monocarboxylic acids, C₁₋₄ allyl mono- and diesters of aliphatic C₄₋₂₀ monocarboxylic acids and dicarboxylic acids, C₁₋₄ alkyl esters of aliphatic C₈₋₂₀ monocarboxylic acids and dicarboxylic acids, and C₄₋₂₀ mono- or polycarboxylate derivatives of C₂₋₁₀₀ (poly)glycols or C₂₋₁₀₀ (poly)glycol ethers. In a further embodiment, the C₄-C₃₀ aliphatic acid ester may be a laurate, a myristate, a palmitate, a stearate, an oleates, a sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-oleates, glyceryl tri(acetate), glyceryl tri-ester of C₂₋₄₀ aliphatic carboxylic acids, and mixtures thereof. In a further embodiment, the C₄-C₃₀ aliphatic ester is isopropyl myristate, di-n-butyl sebacate and/or pentyl valerate.

In one embodiment, the selectivity control agent and/or activity limiting agent can be added into the reactor separately. In another embodiment, the selectivity control agent and the activity limiting agent can be mixed together in advance and then added into the reactor as a mixture. In addition, the selectivity control agent and/or activity limiting agent can be added into the reactor in different ways. For example, in one embodiment, the selectivity control agent and/or the activity limiting agent can be added directly into the reactor, such as into a fluidized bed reactor. Alternatively, the selectivity control agent and/or activity limiting agent can be added indirectly to the reactor volume by being fed through, for instance, a cycle loop. The selectivity control agent and/or activity limiting agent can combine with the catalyst particles within the cycle loop prior to being fed into the reactor.

In one embodiment, the catalyst system of the present disclosure can include a second selectivity control agent that can optionally be used in conjunction with the first selectivity control agent. The second selectivity control agent can comprise an alkoxysilane. In one embodiment, the alkoxysilane can have the following general formula: SiRₘ(OR′)₄₋ₘ (I) where R independently each occurrence is hydrogen or a hydrocarbyl or an amino group optionally substituted with one or more substituents containing one or more Group 14, 15, 16, or 17 heteroatoms, said R containing up to 20 atoms not counting hydrogen and halogen; R′ is a C₁₋₄ alkyl group; and m is 0, 1, 2 or 3. In an embodiment, R is C₆₋₁₂ aryl, alkyl or aralkyl, C₃₋₁₂ cycloalkyl, C₃₋₁₂ branched alkyl, or C₃₋₁₂ cyclic or acyclic amino group, R′ is C₁₋₄ alkyl, and m is 1 or 2. In one embodiment, for instance, the second selectivity control agent may comprise n-propyltriethoxysilane.

The catalyst system of the present disclosure as described above can be used for producing olefin-based polymers. The process includes contacting an olefin with the catalyst system under polymerization conditions.

One or more olefin monomers can be introduced into a polymerization reactor to react with the catalyst system and to form a polymer, such as a fluidized bed of polymer particles. Nonlimiting examples of suitable olefin monomers include ethylene, propylene, C₄₋₂₀ α-olefins, such as 1-butene, 1-pentene, 1-hexene, 4-methyl-1-pentene, 1-heptene, 1-octene, 1-decene, 1-dodecene and the like; C₄₋₂₀ diolefins, such as 1,3-butadiene, 1,3-pentadiene, norbornadiene, 5-ethylidene-2-norbornene (ENB) and dicyclopentadiene; C₈₋₄₀ vinyl aromatic compounds including styrene, o-, m-, and p-methylstyrene, divinylbenzene, vinylbiphenyl, vinylnapthalene; and halogen-substituted C₈₋₄₀ vinyl aromatic compounds such as chlorostyrene and fluorostyrene.

As used herein, “polymerization conditions” are temperature and pressure parameters within a polymerization reactor suitable for promoting polymerization between the catalyst composition and an olefin to form the desired polymer. The polymerization process may be a gas phase, a slurry, or a bulk polymerization process, operating in one, or more than one reactor.

In one embodiment, polymerization occurs by way of gas phase polymerization. As used herein, “gas phase polymerization” is the passage of an ascending fluidizing medium, the fluidizing medium containing one or more monomers, in the presence of a catalyst through a fluidized bed of polymer particles maintained in a fluidized state by the fluidizing medium. “Fluidization,” “fluidized,” or “fluidizing” is a gas-solid contacting process in which a bed of finely divided polymer particles is lifted and agitated by a rising stream of gas. Fluidization occurs in a bed of particulates when an upward flow of fluid through the interstices of the bed of particles attains a pressure differential and frictional resistance increment exceeding particulate weight. Thus, a “fluidized bed” is a plurality of polymer particles suspended in a fluidized state by a stream of a fluidizing medium. A “fluidizing medium” is one or more olefin gases, optionally a carrier gas (such as H₂ or N₂) and optionally a liquid (such as a hydrocarbon) which ascends through the gas-phase reactor.

A typical gas-phase polymerization reactor (or gas phase reactor) includes a vessel (i.e., the reactor), the fluidized bed, a distribution plate, inlet and outlet piping, a compressor, a cycle gas cooler or heat exchanger, and a product discharge system. The vessel includes a reaction zone and a velocity reduction zone, each of which is located above the distribution plate. The bed is located in the reaction zone. In an embodiment, the fluidizing medium includes propylene gas and at least one other gas such as an olefin and/or a carrier gas such as hydrogen or nitrogen.

In one embodiment, the contacting occurs by way of feeding the catalyst composition into a polymerization reactor and introducing the olefin into the polymerization reactor. In an embodiment, the cocatalyst can be mixed with the catalyst composition (pre-mix) prior to the introduction of the catalyst composition into the polymerization reactor. In another embodiment, the cocatalyst is added to the polymerization reactor independently of the catalyst composition. The independent introduction of the cocatalyst into the polymerization reactor can occur simultaneously, or substantially simultaneously, with the catalyst composition feed.

In the past, many gas phase polymerization processes were conducted with a pre-polymerization step. Pre-polymerization includes contacting a small amount of the olefin monomer with the catalyst system to produce small amounts of polymer. The catalyst system of the present disclosure, however, can be used without a pre-polymerization step due to the improved kinetics of the catalyst system. By eliminating the pre-polymerization step, throughput of the polymer can be improved in addition to reducing the complexity of the process.

In one embodiment, the polymerization process may include a pre-activation step. Pre-activation includes contacting the catalyst composition with the co-catalyst and the selectivity control agent and/or the activity limiting agent. The resulting preactivated catalyst stream is subsequently introduced into the polymerization reaction zone and contacted with the olefin monomer to be polymerized. Optionally, additional quantities of the selectivity control agent and/or the activity limiting agent may be added.

The process can include mixing the selectivity control agent (and optionally the activity limiting agent) with the catalyst composition. The selectivity control agent can be complexed with the cocatalyst and mixed with the catalyst composition (pre-mix) prior to contact between the catalyst composition and the olefin. In another embodiment, the selectivity control agent and/or the activity limiting agent can be added independently to the polymerization reactor. In one embodiment, the selectivity control agent and/or the activity limiting agent can be fed to the reactor through a cycle loop.

Various different types of polymers can be produced using a catalyst system of the present disclosure. For instance, the catalyst system can be used to produce polypropylene homopolymers, polypropylene copolymers, and polypropylene terpolymers. The catalyst system can also be used to produce impact resistant polymers that have elastomeric properties.

Impact resistant polymers that have rubber-like or elastomeric properties are typically made in a two reactor system where it is desirable for the catalyst to maintain high activity levels. In one embodiment, for instance, the polymerization is performed in two reactors connected in series. A propylene homopolymer or a propylene copolymer can be formed in the first reactor in order to form an active propylene-based polymer. The active propylene-based polymer from the first polymerization reactor is then introduced into a second polymerization reactor and contacted, under second polymerization conditions, with at least one second monomer in the second reactor to form a propylene impact copolymer. In one embodiment, the process includes contacting the active propylene-based polymer with propylene and ethylene in the second polymerization reactor under polymerization conditions and forming a discontinuous phase of propylene/ethylene copolymer.

As described above, the first phase polymer can comprise a polypropylene homopolymer. In an alternative embodiment, however, the first phase polymer may comprise a random copolymer of polypropylene.

The random copolymer, for instance, can be a copolymer of propylene and an alpha-olefin, such as ethylene. The polypropylene random copolymer forms the matrix polymer in the polypropylene composition and can contain the alpha-olefin in an amount less than about 12% by weight, such as in an amount less than about 5% by weight, such as in an amount less than about 4% by weight, and generally in an amount greater than about 0.5% by weight, such as in an amount greater than about 1% by weight, such as in an amount greater than about 1.5% by weight, such as in an amount greater than about 2% by weight.

The second phase polymer is a propylene and alpha-olefin copolymer. The second phase polymer, however, has elastomeric or rubber-like properties. Thus, the second phase polymer can dramatically improve the impact strength resistance of the polymer.

The second phase polymer which forms a dispersed phase within the polymer composition contains the alpha-olefin or ethylene in an amount generally greater than about 10% by weight, such as in an amount greater than about 12% by weight, such as in an amount greater than about 14% by weight and generally less than about 30% by weight, such as less than about 20% by weight, such as in an amount less than about 17% by weight.

As described above, the catalyst system of the present disclosure can produce various different polymers having relatively high bulk densities and containing a dramatically reduced amount of fines. For example, polypropylene homopolymers, polypropylene random copolymers containing, for instance, greater than 3.5 weight % ethylene, and polypropylene terpolymers can be produced according to the present disclosure all containing less than 1% fines, such as less than about 0.8% fines, such as less than about 0.5% fines, such as even less than about 0.4% fines. Each of the polymers described above can also have a relatively high bulk density. The bulk density, for instance, can be greater than about 0.38 g/cc, such as greater than about 0.4 g/cc, such as greater than about 0.42 g/cc, such as greater than about 0.45 g/cc. The bulk density is generally less than about 0.6 g/cc, such as less than about 0.55 g/cc.

### EXAMPLES

Various different polymers were produced using the catalyst system of the present disclosure. More particularly, the LYNX 1010 catalyst obtained from W.R. Grace and Company was combined with the selectivity control agent of the present disclosure to produce polypropylene-ethylene random copolymers and terpolymers. The reactor conducted polymerization in a gas-phase fluidized bed with a compressor and cooler connected to a cycle gas line.

Polypropylene resin powder was produced in the fluidized bed reactor using the LYNX 1010 catalyst in combination with triethylaluminum as a cocatalyst. The catalyst system further included a selectivity control agent in accordance with the present disclosure, namely diisobutyldimethoxysilane. Isopropyl myristate was added as an activity limiting agent. The ratio of diisobutyldimethoxysilane to isopropyl myristate was 4:1.

For purposes of comparison, polypropylene polymers were also produced using the LYNX 1010 catalyst as described above. In the comparative examples, however, different selectively control agents were used.

Polymer powders were produced over a range of melt flow rates, xylene solubles, and ethylene rubber content by varying reactor conditions and using a second reactor in series for producing the elastomeric polymers. The bulk density and fines of the polymers produced were measured and compared to polymers produced under similar conditions with the same catalyst but using a different selectivity control agent.

The following catalyst systems were tested:

| Sample No. | Selectivity Control Agent |
|---|---|
| 1 | diisobutyldimethoxysilane |
| 2 | dicyclopolydimethyl silane |
| 3 | n-propyltrimethoxy silane |

The fluidized bed reactor was operated under the following conditions:
Al/Ti mole ratio: 150
Reactor Temperature: 75° C.
Bed weight: 68 to 72 kg
Superficial gas velocity: 1.54 to 1.6 ft/sec

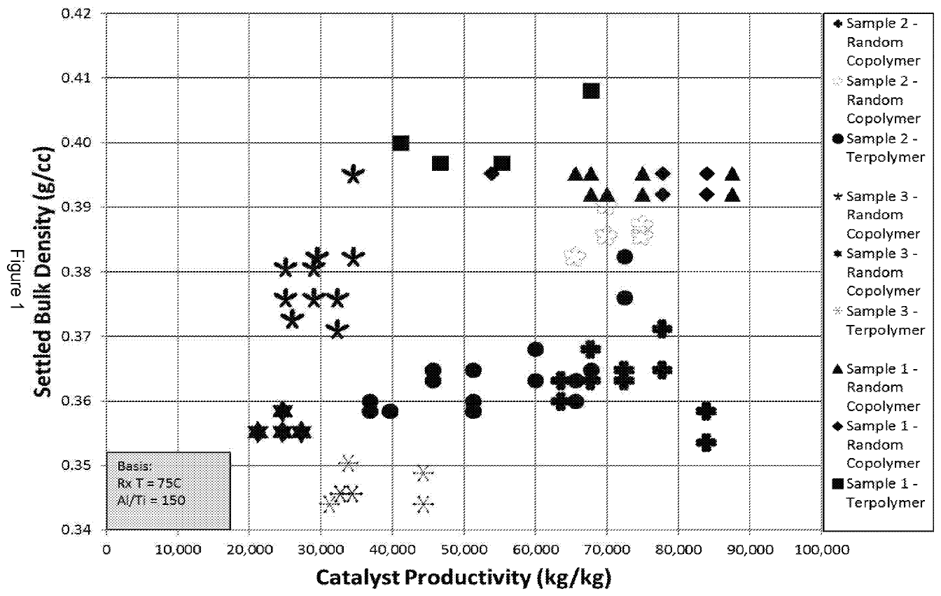

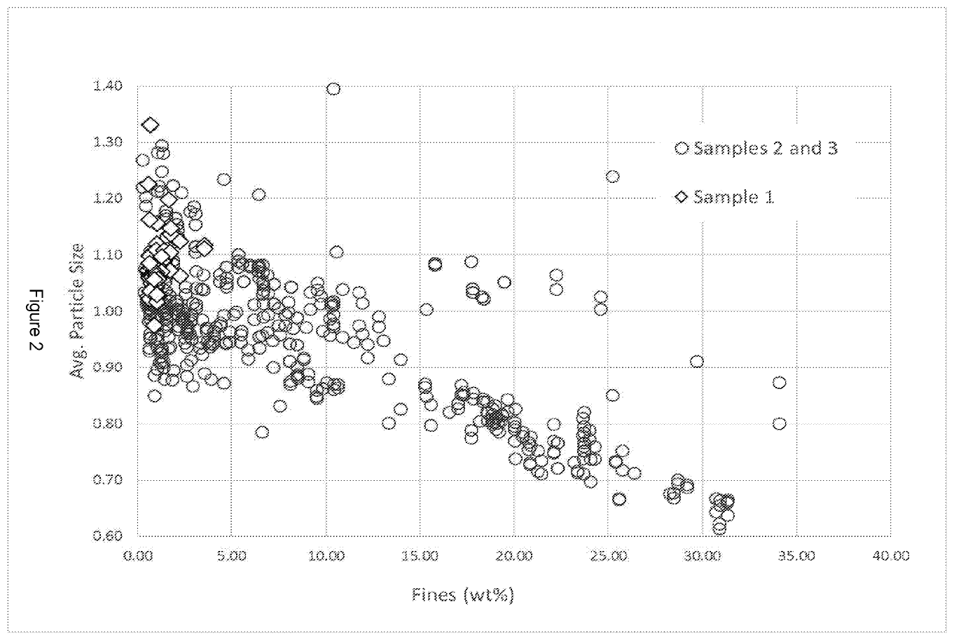

FIGS. 1 and 2 illustrate the results obtained during the experiments. As shown, polypropylene polymers made in accordance with the present disclosure had a bulk density of generally greater than 0.38 g/cc and had a higher bulk density than the other polymers produced with the same catalyst particles but using a different selectivity control agent. As shown in FIG. 2, polymers were produced according to the present disclosure that contained less than 1% fines by weight. The data presented in FIG. 2 also includes data related to the production of polypropylene homopolymers.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention as further described in such appended claims.

1. A process for producing olefin polymers comprising:
polymerizing an olefin in the presence of a Ziegler-Natta catalyst system in a gas phase polymerization reactor, the catalyst system including a solid catalyst component, a selectivity control agent, and optionally an activity limiting agent, the solid catalyst component comprising a magnesium moiety, a titanium moiety, and an internal electron donor, the selectivity control agent comprising a silane having the following chemical structure: 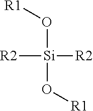
wherein R₁ is a C1 to C6 alkyl group, and R₂ is a C3 to C8 branched alkyl group.

2. The process as defined in claim 1, wherein the selectivity control agent comprises diisobutyldimethoxysilane.

3. The process as defined in claim 1, wherein the catalyst system includes the activity limiting agent.

4. The process as defined in claim 3, wherein the activity limiting agent comprises isopropyl myristate, pentyl valerate, or mixtures thereof.

5. The process as defined in claim 1, wherein the catalyst system further comprises a second selectivity control agent.

6. The process as defined in claim 5, wherein the second selectivity control agent comprises propyltriethoxysilane.

7. The process as defined in claim 1, wherein the catalyst system is a non-pre prepolymerized catalyst system.

8. The process as defined in claim 1, wherein R₁ is a methyl group.

9. (canceled)

10. The process as defined in claim 1, wherein the catalyst system further comprises a cocatalyst.

11. (canceled)

12. The process as defined in claim 1, wherein the solid catalyst component further contains an organic phosphorus compound, an organosilicon compound, and an epoxy compound.

13. (canceled)

14. The process as defined in claim 1, wherein the olefin comprises a propylene for producing a propylene homopolymer and wherein the polypropylene homopolymer has a bulk density of greater than about 0.38 g/cc and contains less than 1% by weight fines.

15. (canceled)

16. The process as defined in claim 1, wherein the olefin comprises propylene and ethylene for forming a propylene and ethylene copolymer.

17. The process as defined in claim 16, wherein the process produces a heterophasic polymer, wherein the heterophasic polymer comprises a first polymer phase comprising a polypropylene homopolymer or a polypropylene random copolymer, the heterophasic polymer further comprising a second polymer phase combined with the first polymer phase, the second polymer phase comprising an elastomeric propylene ethylene copolymer and wherein the first polymer phase is formed in the gas phase polymerization reactor and the second polymer phase is formed in a second reactor, the catalyst system remaining active in both the first reactor and the second reactor.

18-20. (canceled)

21. The process as defined in claim 1, wherein the olefin comprises a mixture of three olefin monomers for forming a terpolymer.

22. The process as defined in claim 21, wherein the terpolymer contains less than 1% by weight fines.

23. The process as defined in claim 1, wherein the selectivity control agent is added directly into a fluidized bed of the gas phase polymerization reactor.

24. The process as defined in claim 1, wherein the selectivity control agent is added to a cycle loop that is in communication with a fluidized bed of the gas phase polymerization reactor.

25. A non-prepolymerized catalyst system comprising:
a solid catalyst component, the solid catalyst component comprising a magnesium moiety, a titanium moiety, and an internal electron donor;
a cocatalyst comprising an alkyl aluminum compound;
a selectivity control agent comprising diisobutyldimethoxysilane; and
optionally an activity limiting agent.

26. The non-prepolymerized catalyst system as defined in claim 25, wherein the catalyst system includes the activity limiting agent, the activity limiting agent comprising a carboxylic acid ester, the activity limiting agent being present in the catalyst system in relation to one or more selectivity control agents at a molar ratio of from about 90:10 to about 50:50.

27. The non-prepolymerized catalyst system as defined in claim 25, wherein the catalyst system includes a second selectivity control agent, the second selectivity control agent comprising a silane.
